(19) United States
(12) Patent Application Publication
(10) Pub. No.: US 2005/0266837 A1
(43) Pub. Date: Dec. 1, 2005

(54) Method and system of preparing message using common phrases in mobile communication terminal

(75) Inventor: Chae Yi Lim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Pantech Co. Ltd.

(21) Appl. No.: 11/083,394

(22) Filed: Mar. 18, 2005

(30) Foreign Application Priority Data
May 31, 2004 (KR) 10-2004-0038923

(51) Int. Cl. H04M 11/00

(52) U.S. Cl. 455/418

(57) ABSTRACT

Disclosed are a method and a system of preparing a message in a mobile communication terminal. According to the invention, common phrases to be stored in a mobile communication terminal are classified by groups, so that it is possible to search a desired common phrase according to the groups when preparing a message. In addition, when one common phrase is selected, one or more of other common phrases in the same group is automatically connected and inserted into the message together with the selected common phrase, so that it is possible to quickly prepare the message.

### CROSS-REFERENCE TO RELATED APPLICATION

The present application is claiming priority of Korean Patent Application No. 10-2004-0038923, filed on May 31, 2004, the content of which is herein incorporated by reference.

### BACKGROUND OF THE INVENTION

1. Field of the Invention

The present invention relates to a method and a system of preparing a message in a mobile communication terminal. According to the invention, common phrases to be stored in a mobile communication terminal are classified by groups, so that it is possible to search a desired common phrase by the groups when making a message. In addition, when one common phrase is selected, one or more of other common phrases in the same group is automatically connected and inserted into the message together with the selected common phrase, so that it is possible to quickly prepare the message.

2. Description of the Related Art

A mobile communication terminal recently used provides functions such as data communications, SMS (Short Message Service), MMS (Multimedia Messaging Service) capable of transmitting multimedia contents as well as an audio communication. Particularly, since the short message service has no restrictions of time and place, many users use it.

Like this, when a short message is transmitted using a mobile communication terminal, a preparation of the short message is prepared by manipulating a keypad of the mobile communication terminal. However, it is generally takes much time to prepare a message with a manipulation of the keypad of the mobile communication terminal, except for a very skilled user.

For example, a user should put up with an inconvenience of manipulating the keypad several tens times for preparing and preparing a short message. In addition, a user who is not familiar with a character combination supported by the mobile communication terminal will consume much more time to prepare the message.

In addition, it will take much more time to prepare a message with a keypad of a mobile communication terminal than with a computer keyboard. This results from that the number of keys constituting the keypad of the mobile communication terminal is much smaller than that of keys constituting the computer keyboard. Additionally, the key of the mobile communication terminal is small and thus it is difficult to manipulate the keypad. This also contributes to the much consumption of time to manipulate the keypad.

Like this, in order to solve the problem of consuming much time for preparing a message, it is used that common phrases repeatedly and frequently used in preparing a message are stored in a memory part of the mobile communication terminal.

The common phrases are stored as follows. For example, serial numbers are assigned to the common phrases in order of high frequency of use and stored in memory of the mobile communication terminal. Then, when displaying a list of the common phrases, a common phrase having a serial number corresponding to a high frequency of use is displayed preferentially. A user selects a serial number corresponding to a desired common phrase among the common phrases displayed as described above, and then inserts the desired common phrase into a message.

However, according to the prior art, if there are many lists of the stored common phrases, a user should consume much time to search a desired common phrase. For example, it is often necessary to use diverse common phrases, depending on the other party receiving a message, or a time or day at which the message is prepared. However, when many common phrases are stored, it will take much time to search a common phrase suitable for the other party receiving the message or a time to prepare the message.

In addition, in case that a user intends to insert plural common phrases into one message in preparing, each of common phrases is searched selected and inserted individually. Accordingly, except for that the common phrases to be inserted into a message are not gathered in one list of the common phrases, it is obvious that it will take much time to search each of the common phrases.

Like this, if it will take much time to search the common phrases, there is no substantial advantage of storing the common phrases, since there may occur a case that it will take much more time to search a desired common phrase than to newly prepare the common phrase or similar.

In summary, an preparing function of a short message provided by the prior mobile communication terminal has a problem that if there are many common phrases, it takes much time to search the common phrases, so that there is no temporal difference, comparing with a preparation of a new message without an insert of the common phrase. Accordingly, there is a need of a method capable of quickly searching the common phrases stored in the mobile communication terminal.

### SUMMARY OF THE INVENTION

Accordingly, the present invention has been prepared to solve the above-mentioned problems occurring in the prior art. The object of the present invention is to provide a method and a system of preparing a message in a mobile communication terminal capable of quickly searching common phrases by classifying the common phrases in a memory part of the mobile communication terminal by groups.

The other object of the invention is such that when one common phrase in the same group is selected, the selected common phrase and one or more of other common phrases belonging to the same group are automatically connected and inserted into a message, so that a user can prepare intended message quickly.

In order to accomplish the above objects, there is provided a method of preparing a message using a common phrase in a mobile communication terminal comprising steps of converting an operation mode of the mobile communication terminal into a mode in which a common phrase can be inserted; displaying a list of one or more common phrase groups previously stored on a display part; displaying a list of common phrases contained in a common phrase group selected among the common phrase groups displayed on the display part; and inserting a common phrase and one or more of other common phrases contained in the selected common phrase group into a message selected among the common phrases displayed on the display part.

Preferably, the common phrase groups may be deleted or added or names thereof can be changed by a user of the mobile communication terminal.

In addition, the common phrase groups may comprise a main common phrase frequently used and a sub common phrase successively following the main common phrase, according to each of themes.

Further, according to a preferred embodiment of the invention, the method may further comprises a step of checking a present time at which the message is preparing; and a step of inserting the time common phrase setup to be inserted when the message is preparing at the checked time.

In order to achieve the above objects, there is provided a system of preparing a message using a common phrase in a mobile communication terminal comprising an input part for inputting a command signal regarding a message preparing; a memory part storing each of common phrases used in the message preparing by common phrase groups; a control part calling a common phrase selected according to the command signal and one or more of other common phrases contained in a common phrase group to which the selected common phrase belongs and displaying the common phrases together on a display part; and a display part displaying contents of the message according to a control of the control part.

Preferably, the common phrase groups stored in the memory part may comprise a main common phrase frequently used and a sub common phrase successively following the main common phrase according to each of themes.

In addition, the common phrase groups stored in the memory part may comprise a common phrase setup to be inserted into the message automatically when the message is prepared on a determined time or day previously.

In order to achieve the above objects, there is provided a system of preparing a message using a common phrase in a mobile communication terminal comprising an input part for inputting a command signal regarding a message preparing; 1st memory part storing each of common phrases used in the message preparing by common phrase groups; 2nd memory part storing at least one of a phone number group linked with at least one of the common phrase groups; a controller inserting the common phrases of the common phrase group into the message when any person who belongs to one of the phone number group was selected as the message's receiver, the common phrase group was linked with the phone number group containing the phone number of the selected person; and a display part displaying contents of the message according to a control of the control part.

### BRIEF DESCRIPTION OF THE DRAWINGS

The above and other objects, features and advantages of the present invention will be more apparent from the following detailed description taken in conjunction with the accompanying drawings, in which:

FIG. 1 is a flow chart showing a message preparing method according to an embodiment of the invention.

FIG. 2 shows a process of making a message using common phrases according to an embodiment of the invention.

FIG. 3 is a block diagram showing a system of editing message using common phrases according to an embodiment of the invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

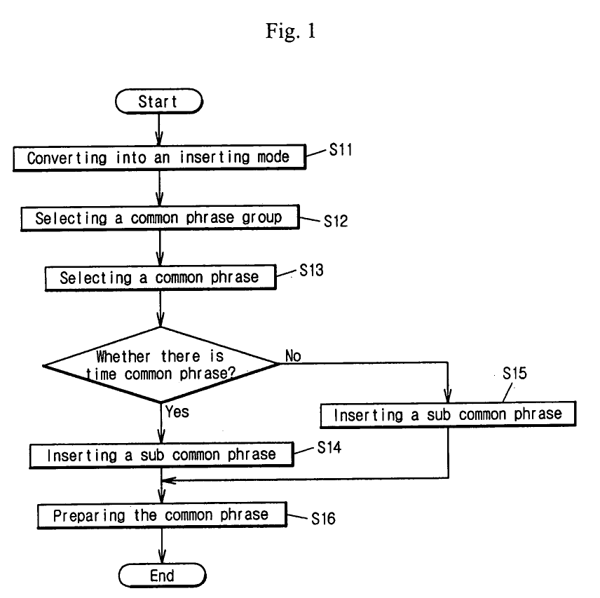

FIG. 1 is a flow chart showing a message preparing method according to an embodiment of the invention. Preferentially, phrases that a user intends use them frequently should be stored as a common phrase. According to the prior art, plural common phrases are stored in one area of mobile communication terminal without any classification. However, according to an embodiment of the invention, an area in which the common phrases are stored is classified into one or more common phrase group and the common phrases are stored in divided state by the common phrase groups.

It can be structured to that user can select which of common phrase groups to store some common phrases. For example, a user can newly make common phrase groups and then assign a name to each of the common phrases, such as Greetings, health, congratulation, consolation, appreciation, love, friendship, friend, and family, etc.

A user stores common phrases in some common phrase groups by considering both contents meanings of the common phrases and the names of the common phrase groups. For example, if a phrase to be stored relates to a congratulatory address, it would be preferable that the phrase is stored in a common phrase group named as ‘congratulation’. In addition, if a phrase to be stored is mainly used in a message to be transmitted to a friend, it would be preferable that the phrase is stored in a common group named as ‘friend’.

Of course, it is also possible to store one word or sentence in the plural common phrase groups respectively. For example, when a phrase to be stored is ‘Greetings to a friend’, it can be stored both in a common phrase group named as a ‘Greetings’ and a common phrase group named as a ‘friend’ at the same time. Like this, it is possible to construct the common phrase groups and names thereof so that a user can arbitrarily delete/change/add them.

Meanwhile, the common phrases to be stored in a same common phrase group can be classified into a main common phrase and a sub common phrase. For instance, a phrase frequently used is stored as the main common phrase and a phrase that can naturally follow the phrase stored as the main common phrase is stored as the sub common phrase.

A common phrase used on a specific day or time (referred as ‘time common phrase’ hereinafter) is stored together with information for the specific day or time. For example, since a common phrase such as ‘Did you have a good weekend?’ is suitable for inserting to a short message that will be transmitted on Monday, it is desirable to set up the common phrase to be inserted automatically into a message being prepared on Monday.

Like this, in case that the common phrases are stored in divide state by the groups, when preparing a short message, a user manipulates to convert an operating mode of the mobile communication terminal into a mode in which the common phrase can be inserted (S11). After then, one of the common phrase groups is selected (S12), and then a common phrase, which is desired to be inserted into a message, of the common phrases stored in the selected common phrase group is selected (S13).

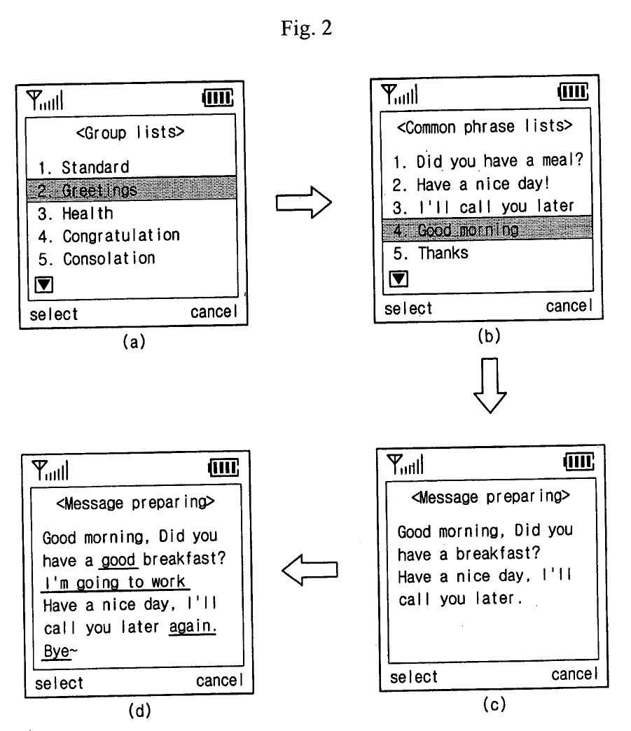

FIG. 2 shows a process of making a message using common phrases according to an embodiment of the invention. As described above, when an operating mode of the mobile communication terminal is converted into a mode in which a common phrase can be inserted (S11), it can be structured to such that contents as shown in Screen (a) of FIG. 2 can be displayed. When a user selects a group of “2. Greetings” among the common phrase groups shown in screen (a) of FIG. 2 by manipulating a keypad of the mobile communication terminal, the common phrases stored in the group of “2. Greetings” are displayed as shown in screen (b) of FIG. 2. Then, when the user selects, for example, a common phrase of “4. Good morning” among the common phrases displayed on a screen (b) of FIG. 2, the selected common phrase and a sub common phrase thereof are displayed together on the display part.

In other words, in the embodiment shown in FIG. 2, the common phrase of “4. Good morning” is selected as a main common phrase, and the common phrases of “1. Did you have a breakfast?”, “2. Have a nice day”, and “3. I'll call you later”, which are previously stored as sub common phrases of “4. Good morning”, are thus automatically connected and displayed. Like this, according to the invention, since it is possible to call plural common phrases having related meaning mutually at the same time with only one selection of common phrase, time consumed due to the keypad manipulation can be sufficiently reduced.

Under the state that the main and sub common phrases are displayed together, the user can prepare an intended message as shown in screen (d) of FIG. 2 by adding some other phrases(or words).

We can know from the screen (d) of FIG. 2 that the user adds word and sentence to the message as follows; “good, “I'm going to work”, “again” and “Bye˜”.

Meanwhile, a method of preparing message according to the invention may further comprises a step of inserting a common phrase setup to be inserted on a present time or day at which a message is being prepared into the message.

For example, when the main common phrase is selected (S13), a control part of the mobile communication terminal searches whether a common phrase, which is setup to be inserted into a message to be prepared on a present time or day, exists not. If there is a common phrase which is setup to be inserted into a message to be prepared on a present time, the time common phrase is inserted into the message together with the selected common phrase (S14). On the contrary, if there is not a common phrase which is setup to be inserted into a message to be prepared on a present time or day, only a common phrase, which is setup as a sub common phrase of the selected main common phrase and has no relation with the time on which a message is preparing is inserted (S15).

For instance, a common phrase setup to be called on the morning or afternoon, a common phrase setup to be called on a specific month or season, or a common phrase setup to be called on a specific day of the week is stored in a memory part of the mobile communication terminal as a time common phrase. Time common phrase is a class of sub common phrase. If there is a time common phrase setup to be called on a present time or day at which a message is being prepared, it is inserted into the message together with its main phrase (S14).

On the contrary, the common phrase having no relation with a time or day at which a message is being prepared is not called although it is stored as a time common phrase. In addition, when there are plural common phrases setup to be called on a time or day at which a message is being prepared, all of the common phrases can be called.

Like this, under a state that the main and sub common phrases are called and inserted into a message, the user can edit the called common phrases and thus prepare an intended message by adding a new sentence, or deleting or correcting a part of the called common phrases (S16).

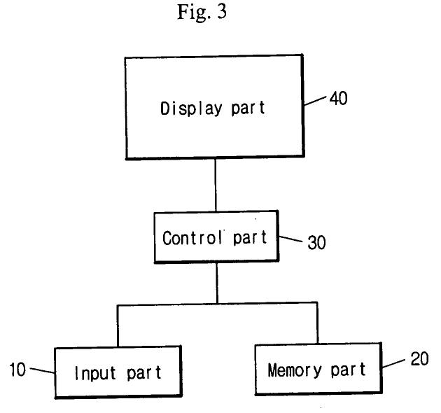

Meanwhile, a message preparing system according to an embodiment of the invention can comprise an input part 10, a memory part 20, a control part 30 and a display part 30 as shown in FIG. 3.

The input part 10 is a means for inputting diverse command signals such as selections of a group and a common phrase, and a preparation of a text.

The memory part 20 stores common phrases. The common phrase is classified into a main common phrase and a sub common phrase which is inserted into a message together with a main common phrase when the main common phrase is selected. The connection information about the main and sub common phrases is stored in the memory part 20. In addition, the memory part 20 also stores information about a time common phrase which inserted into a message being prepared on a specific time or day.

The control part 30 performs functions of calling the common phrase stored in the memory part 20 according to the command signal of the input part 10 and then inserting it into a message. As described above, when one common phrase group is selected, a common phrase contained in the selected common phrase group is called from the memory part 20 and displayed. After then, when one of the common phrases displayed on the display part 40 is selected, the selected common phrase and one or more of other common phrases contained in the selected common phrase group are called from the memory part 20 and displayed together with the selected common phrase on the display part 40.

In addition, among the common phrases stored in the memory part 20, when there is a common phrase setup to be called on a time or day at which a message is being prepared, it is called and displayed together with the main message.

The display part 40 displays preparing contents of a message according to a control of the control part 30. A user edits a message with recognizing the message contents displayed on the display part 40.

As described above, according to the invention, the common phrases are separately stored in divided state by the groups, so that it is possible to quickly search the common phrases.

In addition, according to the invention, when one common phrase of the common phrase stored in the same group is selected, the selected common phrase and one or more of other common phrases belonging to the same group are automatically connected and inserted together into a message, so that it is possible to quickly prepare a message.

The present invention also provides a system of preparing a message using a common phrase in a mobile communication terminal comprising an input part for inputting a command signal regarding a message preparing; 1st memory part storing each of common phrases used in the message preparing by common phrase groups; 2nd memory part storing at least one of a phone number group linked with at least one of the common phrase groups; a controller inserting the common phrases of the common phrase group into the message when any person who belongs to one of the phone number group was selected as the message's receiver, the common phrase group was linked with the phone number group containing the phone number of the selected person; and a display part displaying contents of the message according to a control of the control part.

We describe an preferred embodiment of the above invention. Let us suppose, for example, there is any common phrase group stored in 1st memory part and there is any phone number group stored in 2nd memory part, but both of them are linked of each other.

Under these conditions, the controller of the mobile communication terminal may insert the common phrases of the common phrase group, if any person who belongs to one of the phone number group was selected.

The phone number group may be linked with a plural common phrase group and vice versa, too. But, it is preferable to one-to-one linkage between the phone number group and the common phrase group from an aspect of simplicity. It is also preferable that both of the phone number group and the common phrase group have same name in the one-to-one linkage.

The 1st memory part and the 2nd memory part may be the memory units separated each other, or may have each region in one memory unit.

While the invention has been shown and described with reference to certain preferred embodiments thereof, it will be understood by those skilled in the art that various changes in form and details may be prepared therein without departing from the spirit and scope of the invention as defined by the appended claims.

1. A method of preparing a message using a common phrase in a mobile communication terminal comprising:
converting an operation mode of the mobile communication terminal into a mode in which a common phrase can be inserted;
displaying a list of one or more common phrase groups previously stored on a display part;
displaying a list of common phrases contained in a common phrase group selected among the common phrase groups displayed on the display part; and
inserting a common phrase and one or more of other common phrases contained in the selected common phrase group into a message selected among the common phrases displayed on the display part.

2. The method according to claim 1, wherein the common phrase groups can be deleted or added or names thereof can be changed by a user of the mobile communication terminal.

3. The method according to claim 1, wherein each of the common phrase groups comprises a main common phrase used frequently and a sub common phrase successively following the main common phrase, according to each of themes.

4. The method according to claim 1, further comprising:
checking a present time at which the message is preparing; and
inserting the time common phrase setup to be inserted when the message is preparing at the checked time.

5. A system of preparing a message using a common phrase in a mobile communication terminal comprising:
an input part for inputting a command signal regarding a message preparing;
a memory part storing each of common phrases used in the message preparing by common phrase groups;
a control part calling a selected common phrase and one or more of other common phrases contained in a common phrase group to which the selected common phrase belongs and displaying the common phrases together on a display part; and
a display part displaying contents of the message according to a control of the control part.

6. The system according to claim 5, wherein each of the common phrase groups comprises a main common phrase frequently used and a sub common phrase successively following the main common phrase according to each of themes.

7. The system according to claim 5, wherein each of the common phrase groups comprises a common phrase setup to be inserted into the message automatically when the message is prepared on a determined time or day previously.

8. A system of preparing a message using a common phrase in a mobile communication terminal comprising:
an input part for inputting a command signal regarding a message preparing;
1 st memory part storing each of common phrases used in the message preparing by common phrase groups;
2nd memory part storing at least one of a phone number group linked with at least one of the common phrase groups;
a controller inserting the common phrases of the common phrase group into the message when any person who belongs to one of the phone number group was selected as the message's receiver, the common phrase group was linked with the phone number group containing the phone number of the selected person; and
a display part displaying contents of the message according to a control of the control part.

9. The system according to claim 8, wherein the phone number group and the common phrase group are linked each other with one-to-one form.

10. The system according to claim 8, wherein the phone number group and the common phrase group have same name each other.
